(19) United States
(12) Patent Application Publication
(10) Pub. No.: US 2019/0224760 A1
(43) Pub. Date: Jul. 25, 2019

(54) Cutting Tool

(71) Applicant: Matsuura Machinery Corporation, Fukui City (JP)

(72) Inventors: Kouichi Amaya, Fukui City (JP); Ryuzo Tanaka, Fukui City (JP); Yoshiaki Kano, Fukui City (JP); Yasunori Takezawa, Fukui City (JP); Tetsuya Igarashi, Fukui City (JP)

(21) Appl. No.: 16/235,373

(22) Filed: Dec. 28, 2018

(30) Foreign Application Priority Data
Jan. 23, 2018 (JP) 2018-008801

(51) Int. Cl. B23B 51/04

(52) U.S. Cl. CPC B23B 51/0486; B23B 2250/12; B23B 2251/207

(57) ABSTRACT

A cutting tool 1 has cutting edges 2 formed by a plurality of side surfaces on both sides 21, 22 raised at a side portion along a longitudinal direction, and the cutting tool 1 in which a coolant passage pipe 30 is extended around a rotation center axis 5, and coolant passage pipes 31 branched from the extended coolant passage pipe 30 are projected along a direction of a raised side surface 21 on a rotating direction side of the raised side surfaces on both sides 21, 22.

### TECHNICAL FIELD

The present invention relates to a cutting tool which forms cutting edges by a plurality of side surfaces on both sides raised at a side portion along a longitudinal direction and which is configured to cool the plurality of cutting edges by coolant ejected from a coolant passage pipe.

### BACKGROUND ART

A variety of configurations have been proposed for a cutting tool in which coolant is used.

However, prior art which has disclosed a configuration in which coolant is directly supplied to a cutting edge to efficiently cool the cutting edge is not readily available and almost an exception.

In particular, in the case of a cutting tool which has cutting edges formed by a plurality of side surfaces on both sides raised at a side portion in a longitudinal direction, there has been so far proposed no particular configuration in which coolant is directly supplied to each of the plurality of cutting edges.

Apart from the above-described cutting tool, as a prior art in which coolant is supplied to a leading end of a cutting edge in a longitudinal direction or in the vicinity of the leading end, for example, in Patent Document 1, a coolant passage pipe (a central conduit 12) extended in the longitudinal direction from a rear surface of a blade 36 of a cutting end portion at a leading end of a cutting tool 30 is used to supply coolant to the blade 36 (Abstract and drawings which are an integral part thereof).

Where the above-described configuration of Patent Document 1 is applied to the cutting tool, the coolant passage pipe is extended up to the leading end of each of the plurality of cutting edges formed by being raised at a side portion in the longitudinal direction and coolant is supplied.

However, the above-described configuration results in reduction in an area of the leading end of the cutting edge which exhibits a cutting function.

In contrast thereto, Patent Document 2 relates to a drill equipped with a curved cutting edge, for a flank 15 that faces a chip-removing groove surface 16, a configuration is adapted such that a coolant is directly supplied to a site of a leading end of a cutting edge 12 in contact with a workpiece by setting an inclined surface which is ground to give an angle at which the coolant ejected from an ejection hole 18 is ejected toward the cutting edge 12 at the leading end (Abstract and FIG. 4).

Where the above-described configuration is applied to cooling of the cutting edge of the cutting tool, coolant is supplied to a site of the leading end of each of the plurality of cutting edges formed by side surfaces on both sides which are raised at a side portion in contact with a workpiece.

However, frictional heat of the cutting edge derived from cutting is transmitted not only to the leading end of the cutting edge but also to an entire area of the cutting edge raised at a side portion in the longitudinal direction. The above-described configuration is not able to cool the entire area or does not necessarily achieve efficient cooling of the cutting edge.

As to the above-described cutting tool, there has been proposed no configuration that cools a wide area of the cutting edge.

### PRIOR ART DOCUMENTS

### Patent Documents

[Patent Document 1] Japanese Unexamined Patent Official Announcement No. 2005-502484
[Patent Document 2] Japanese Published Unexamined Patent Application No. 2016-144865

### SUMMARY OF THE INVENTION

### Technical Problem

An object of the present invention is to provide, in a cutting tool which has cutting edges formed by a plurality of side surfaces on both sides raised in a side portion along a longitudinal direction, a configuration in which a coolant is supplied not only to a leading end of the cutting edge but also to an area facing a rotating direction side, thereby achieving efficient cooling of the cutting edge and removing chips from the cutting edge.

### Solution for Problem

In order to achieve the above object, a basic configuration of the present invention is a cutting tool comprising, the cutting tool has cutting edges formed by a plurality of side surfaces on both sides raised at a side portion along a longitudinal direction, and the cutting tool in which a coolant passage pipe is extended around a rotation center axis, and coolant passage pipes branched from the extended coolant passage pipe are projected along a direction of a raised side surface on a rotating direction side of the raised side surfaces on both sides.

### Advantageous Effects of Invention

In the present invention standing on the basic configuration, a direction at which each of the plurality of branched coolant passage pipes is projected is along the raised side surface on the rotating direction side. Therefore, coolant ejected from an ejection hole at the leading end of the coolant passage pipe flows along the raised side surface, thus making it possible to efficiently cool a wide area which forms the cutting edge.

Further, the coolant which has flowed from the ejection hole flows up to the leading end of the cutting edge and a site thereof in contact with a workpiece, thus making it possible to efficiently remove chips from the cutting edge.

The coolant ejected from the ejection hole contains flowing components in an ejection direction and in the rotating direction at an initial stage of ejection.

However, a flow rate in the projection direction is apparently larger than a rotational speed at the ejection hole and, therefore, the flowing components in the rotating direction will disappear due to air resistance. After the disappearance, the coolant is subjected to a pressure along the rotating direction on the raised side surface to exhibit such a flowing state that the side surface is increased in flowing area. And it is possible to reliably provide aforementioned effects.

### BRIEF EXPLANATION ON DRAWINGS

FIG. 1 shows a cross sectional view of a cutting tool with a configuration of Example 1 in a direction orthogonal to a longitudinal direction thereof.

FIG. 2 shows a cross sectional view of a cutting tool with a configuration of Example 2 in a direction orthogonal to a longitudinal direction thereof.

FIG. 3 shows a first embodiment in which a projected position of a branched coolant passage pipe is at a raised end site or in the vicinity thereof on a side surface on a rotating direction side. FIG. 3(a) is a front view which shows the leading end side thereof (an area of the coolant passage pipe present inside a cutting edge is indicated by a dotted line, a projected area thereof is indicated by a solid line, and the rotating direction of the cutting edge is indicated by a white arrow). FIG. 3(b) is a cross sectional view thereof in a direction orthogonal to the longitudinal direction and shows a flowing state of coolant, with attention given to two cutting edges (a flowing direction of the coolant is indicated by a dotted-line arrow, and the rotating direction of the cutting edge is indicated by a white arrow). FIG. 3(c) is a transverse sectional view along the longitudinal direction of the cutting tool.

FIG. 4 shows a second embodiment in which a projected position of a branched coolant passage pipe is at a halfway site on a side surface on a rotating direction side. FIG. 4(a) is a front view of the leading end side thereof (an area of the coolant passage pipe present inside the cutting edge is indicated by a dotted line, a projected area thereof is indicated by a solid line, and the rotating direction of the cutting edge is indicated by a white arrow). FIG. 4(b) is a cross sectional view thereof in a direction orthogonal to the longitudinal direction and shows a flowing state of coolant, with attention given to two cutting edges (a flowing direction of the coolant is indicated by a dotted line arrow and the rotating direction of the cutting edge is indicated by a white arrow). FIG. 4(c) is a transverse sectional view along the longitudinal direction of the cutting tool.

### DESCRIPTION OF EMBODIMENTS

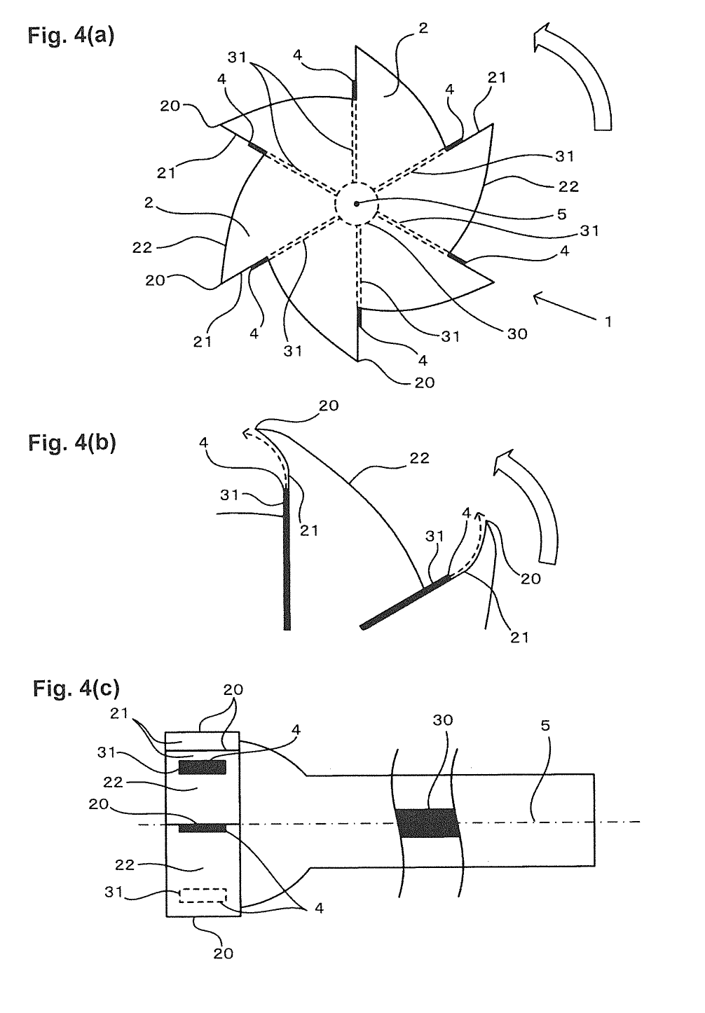

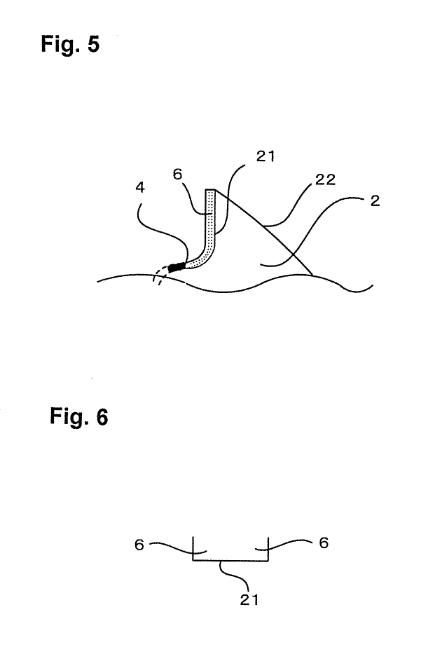

As shown in FIG. 3(a), (b), (c) and FIG. 4(a), (b), (c), in the basic configuration which is based on a cutting tool 1 having cutting edges 2 formed by a plurality of side surfaces on both sides 21, 22 raised at a side portion along a longitudinal direction, a plurality of coolant passage pipes 31 branched from a coolant passage pipe 30 extended around a rotation center are projected along the raised side surface 21 on a rotating direction side, of the side surfaces on both sides 21, 22.

In the first embodiment, as shown in FIG. 3(a), (b), (c), a projected position of the branched coolant passage pipe 31 is at a raised end site on the side surface 21 on the rotating direction side or in the vicinity of an interior thereof.

In the first embodiment, after being ejected from an ejection hole 4 positioned at the leading end of the projected coolant passage pipe 31, coolant flows from the vicinity of the raised end site up to a leading end 20 of the cutting edge. As described previously, a flowing area of the coolant is subjected to a pressure along the rotating direction and increased thereby, thus making it possible to cool a wide area of the raised side surface 21.

As shown in FIGS. 3(a) and (b) in particular, where a raised side surface 21 on the rotating direction side and a raised side surface 22 on reverse to the rotating direction side of the adjacent cutting edge 2 is connected by an inwardly recessed curve surface, the ejected coolant smoothly flows on the raised side surface 21 on the rotating direction side from the end site thereof, thus making it possible to reliably achieve the efficient cooling.

In the second embodiment, as shown in FIG. 4(a), (b), (c), a projected position of the branched coolant passage pipe 31 is at a halfway site on the raised side surface 21 on the rotating direction side.

In the second embodiment, coolant flows up to the leading end 20 of the cutting edge along a part of the raised side surface 21 on the rotating direction side. The second embodiment may be slightly lower in cooling efficiency than the first embodiment in that the coolant does not necessarily flow through a substantially entire area.

However, the raised side surface 21 on the rotating direction side is not made flat as shown in FIG. 4(a), but there is adopted, as shown in FIG. 4(b), such a shape that the raised side surface 21 from the projected position of the branched coolant passage pipe 31 to the leading end 20 of the cutting edge assumes an inwardly recessed curved shape. In this case, it is possible to correct the flowing area which is narrow in width to a substantial extent.

Further, in the second embodiment, as shown in FIG. 4(a), (b), such a simple design can be adopted that the coolant passage pipe 31 is projected on the raised side surface 21 on the rotating direction side.

As shown in FIG. 3(a), (c) and FIG. 4(a), (c), the cutting edge 2 according to the basic configuration is such that the cutting edge 2 is in most cases provided at the leading end in the longitudinal direction or in the vicinity thereof. However, a position at which the cutting edge is provided is not necessarily limited to the above-described position but the cutting edge can be provided at a halfway site in the longitudinal direction.

In order that coolant flows in a wide area of the raised side surface 21 on the rotating direction side after being ejected from the ejection hole 4, as shown in FIG. 3(c) and FIG. 4(c), it is preferable that the branched coolant passage pipe 31 is designed so as to have a predetermined width along the longitudinal direction in an entire branched area or in a halfway-site area leading to the ejection hole 4 at a leading end, that is, that the ejection hole 4 is formed in a long and narrow shape along the longitudinal direction.

As described in the section of Advantageous Effects of Invention, on the raised side surface 21 on the rotating direction side, coolant is subjected to a pressure along the rotating direction, thereby exhibiting a flowing state that the side surface 21 is increased in flowing area.

Where the flowing area is increased beyond a width direction of the side surface 21, that is, a direction orthogonal to a direction from the end site of the side surface 21 to the leading end due to an increase in flowing area, there is a slight possibility that coolant may leak from the side surface 21.

However, in the case that on the side surface 21, a projected portion which faces to the side in the rotating direction is provided along a direction from the raised end site to the leading end at both ends in a direction orthogonal to the above direction, aforementioned possibility can be avoided.

Hereinafter, a description will be given by following examples.

### Example 1

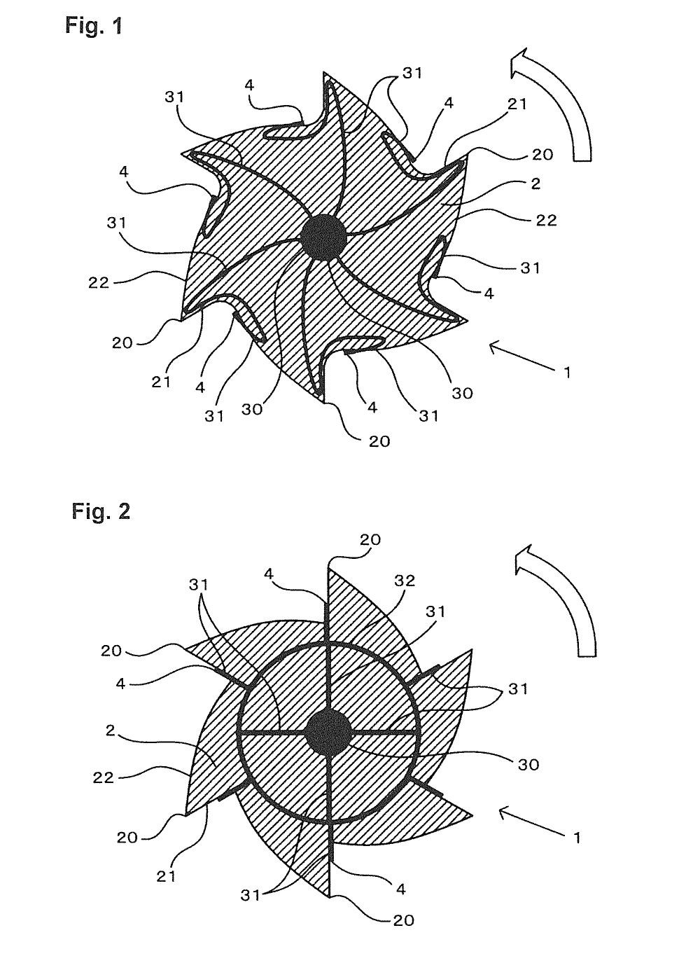

As shown in FIG. 1, in Example 1, a coolant passage pipe 30 extended along a longitudinal direction is adopted, and a branched coolant passage pipe 31 assumes such a shape that the pipe bypasses the vicinity inside the leading end of the raised side surfaces on both sides 21, 22 and then reaches the projected position (FIG. 1 shows a mode of the cutting edge 2 based on the first embodiment).

In Example 1, the bypass configuration is provided in the vicinity inside the leading end 20 of the cutting edge, thus making it possible to promote cooling of the cutting edge 2.

### Example 2

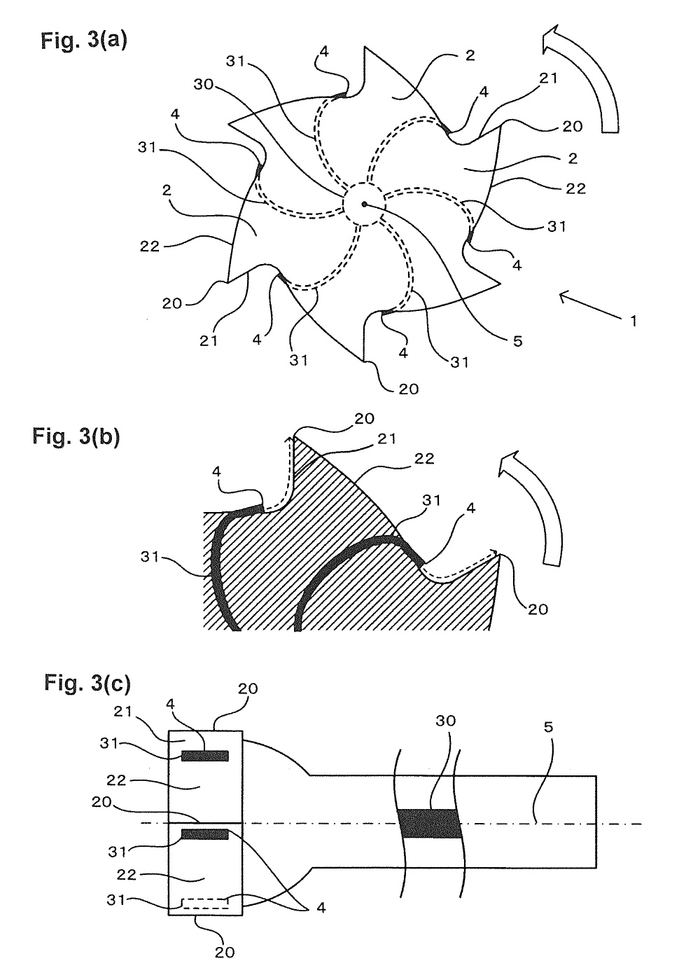

As is shown in FIG. 2, in Example 2, a coolant passage pipe 30 which is extended in a longitudinal direction is adopted and, as shown in FIG. 2, a ring-shaped coolant passage pipe 32 along the rotating direction in the vicinity inside an end site of a raised side surface 21 on the rotating direction side is interposed between the coolant passage pipe 31 branched from the extended coolant passage pipe 30 and the coolant passage pipe 31 leading to each ejection hole 4 (FIG. 2 shows a mode of the cutting edge 2 based on the second embodiment).

As shown in Example 2, by the interposition of the coolant passage pipe 32 formed in a ring shape along the rotating direction, that is, in the ring shape at the center of a rotation center axis 5, to connect a raised side surface 21 of each of the cutting edges 2 on the rotating direction side to a raised side surface 22 on reverse to the rotating direction side, both end sites are cooled to promote further efficient cooling in each of the previous embodiments.

### INDUSTRIAL APPLICABILITY

As described so far, according to the method for cooling the cutting tool in the present invention, it is possible to cool efficiently not only the leading end of a cutting edge responsible for heating but also a raised side surface on a rotating direction side. It is also possible to remove reliably chips produced on a raised side surface on the rotating direction side, which greatly contributes to usefulness of the invention.

### EXPLANATION ON SIGNS

1: Cutting tool
2: Cutting edge
20: Leading end of cutting edge
21: Raised side surface on a rotating direction side
22: Raised side surface on reverse to rotating direction side
30: Coolant passage pipe extended along periphery of rotation center axis
31: Radially branched coolant passage pipe
32: Ring-shaped coolant passage pipe
4: Ejection hole
5: Rotation center axis

1. A cutting tool comprising:
cutting edges formed by a plurality of side surfaces on opposite sides of each cutting edge with the side surfaces being raised regularly along a rotating direction around a rotation center axis at a side portion along a longitudinal direction,
a main coolant passage pipe extended around a rotation center axis of the cutting tool, and
branched coolant passage pipes branched from the extended main coolant passage pipe and projected along a direction of a raised side surface on a rotating direction side of the raised side surfaces on opposite sides,
wherein on an entire area of the raised side surface on the rotating direction side from a raised end site which is at a minimum distance position from the rotation center axis in which the raised side surface starts to a leading end of the raised side surface, a projected portion which faces the rotating direction side is provided along a direction from the raised end site toward the leading end at opposite sides of the raised side surface in a direction orthogonal to a widthwise direction of the raised side surface.
wherein on the raised side surface on the rotating direction side, a projected portion of each branched coolant passage pipe which faces the rotating direction side is provided along a direction from a raised end site toward a leading end at said opposite sides in a direction orthogonal to the longitudinal direction.

2. The cutting tool according to claim 1, wherein a projected position of each branched coolant passage pipe is at a raised end site of one of:
a side surface on the rotating direction side or
a vicinity of an interior of the side surface on the rotating direction side.

3. (canceled)

4. The cutting tool according to claim 1, wherein a projected position of each branched coolant passage pipe is at a halfway site on a raised side surface on the rotating direction side.

5. The cutting tool according to claim 4, wherein a raised side surface from the projected position of each branched coolant passage pipe to a leading end of the cutting edge assumes an inwardly recessed curve shape which is reverse to the rotating direction side.

6. The cutting tool according to claim 1, wherein an ejection hole at a leading end of each branched coolant passage pipe assumes a long and narrow shape along the longitudinal direction.

7. (canceled)

8. The cutting tool according to claim 1, wherein each branched coolant passage pipe assumes a shape that sequently changes in direction such that the pipe bypasses a vicinity of the rotation center axis at a leading end of the raised side surfaces on opposite sides and then reaches a projected position of the raised side surface.

9. The cutting tool according to claim 1, further including:
a ring-shaped coolant passage pipe along the rotating direction at a position between the end site and the rotation center axis, and nearer to the end site than the rotation center axis, and interposed between the main coolant passage pipe and the plurality of coolant passage pipes leading to each ejection hole thereof.
